(19) United States
(12) Patent Application Publication
(10) Pub. No.: US 2005/0046751 A1
(43) Pub. Date: Mar. 3, 2005

(54) Page function for remote control

(76) Inventor: Eddie Korbor Weagar Simmons, Jacksonville, FL (US)

Correspondence Address: EDDIE K W SIMMONS, 7514 PROXIMA RD, JACKSONVILLE, FL, 32210, US

(21) Appl. No.: 10/894,079

(22) Filed: Jul. 20, 2004

Related U.S. Application Data
(60) Provisional application No. 60/498,673, filed on Aug. 28, 2003.

(51) Int. Cl. G06K 1/00; B41B 1/00

(52) U.S. Cl. 348/734

(57) ABSTRACT

The page function for remote control is clearly an audible idea for a common device that anybody and everybody can utilize. The remote control will utilize either triple A (AAA), double A (AA), Nickel Cadmium (NiCad) or Nickel Metal Hydride batteries (NIMH). The remote control itself will be made out of hard plastic or the same material that current remote controls are made out of Because Nickel Cadmium and Nickel Metal Hydride are rechargeable batteries, there would need to be a rechargeable docking station that will house the remote control to charge it when the remote control needs to be charged. The rechargeable docking station will also have a page button to activate the page function in case the remote control is misplaced. The rechargeable docking station will be powered by a class 2 AC/DC transformer or power supply. The remote can control any of the following devices: TV, VCR, DVD, projector, stereo system, video game, radio, and even a car stereo system. The page function can be implemented for standard remote control, universal remote control, and digital touch pad remote control. Authorized electronic manufacturers such as Sony, JVC, RCA, Pioneer, Hitachi, Mitsubishi, GE, Phillips, Magnavox, Toshiba, etc can benefit from this technology. Digital cable boxes and satellite receivers with remote controls can also benefit from this technology. The page function will be activated from each of the following electronic devices that I previously mentioned. For example, each of the electronic manufacturers above makes television. If the remote control to the television is misplaced, there would be a page button on the television to activate the page function. There will also be a page button on the remote control to deactivate the page function once the remote control is found. The example would be the same for DVD, VCR, Stereo, etc. If the remote utilizes either double A (AA) or triple A (AAA) then the page button will be on the electronic device such as T.V., DVD, VCR, and stereo as well as the remote control. On the other hand if the remote utilizes Nickel Cadmium (NiCad) batteries, then the page button will be on the rechargeable docking station as well as the remote control. Universal remotes will more than likely utilize Nickel Cadmium (NiCad) or Nickel Metal Hydride batteries. My sole and main purpose of this idea is to obtain a patent for the page function to benefit electronic consumers who continually endure difficulty finding misplaced remote controls.

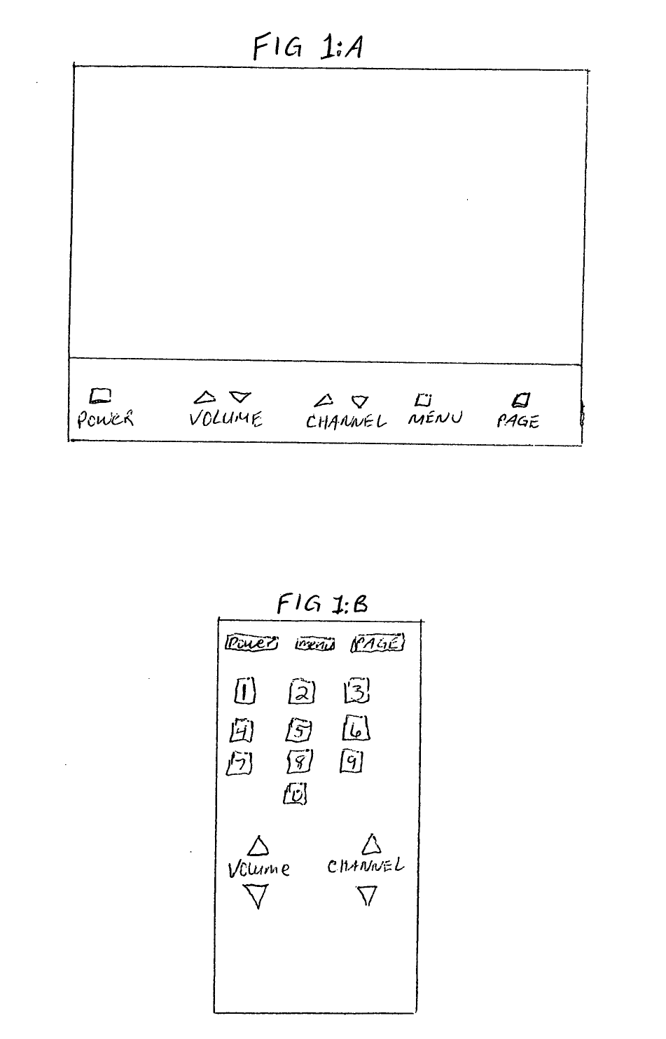

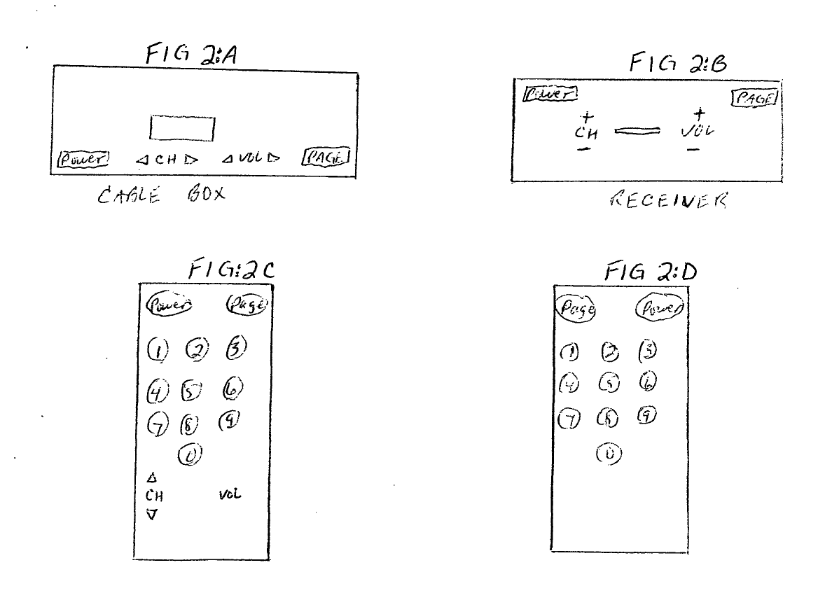

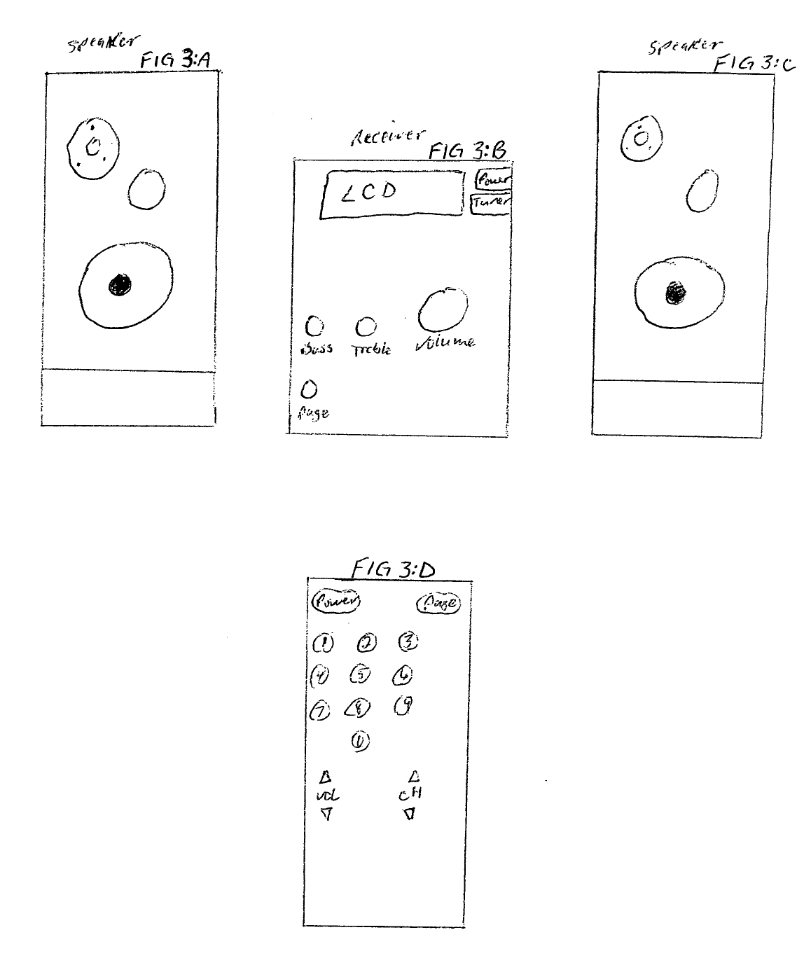

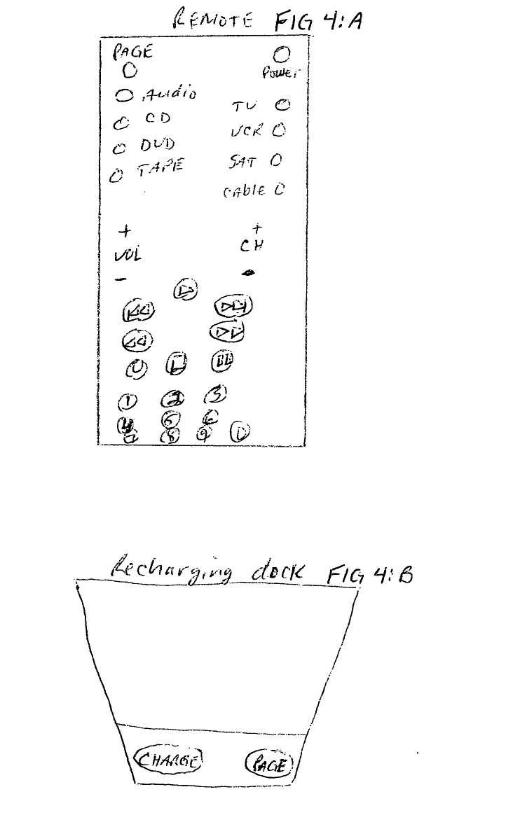

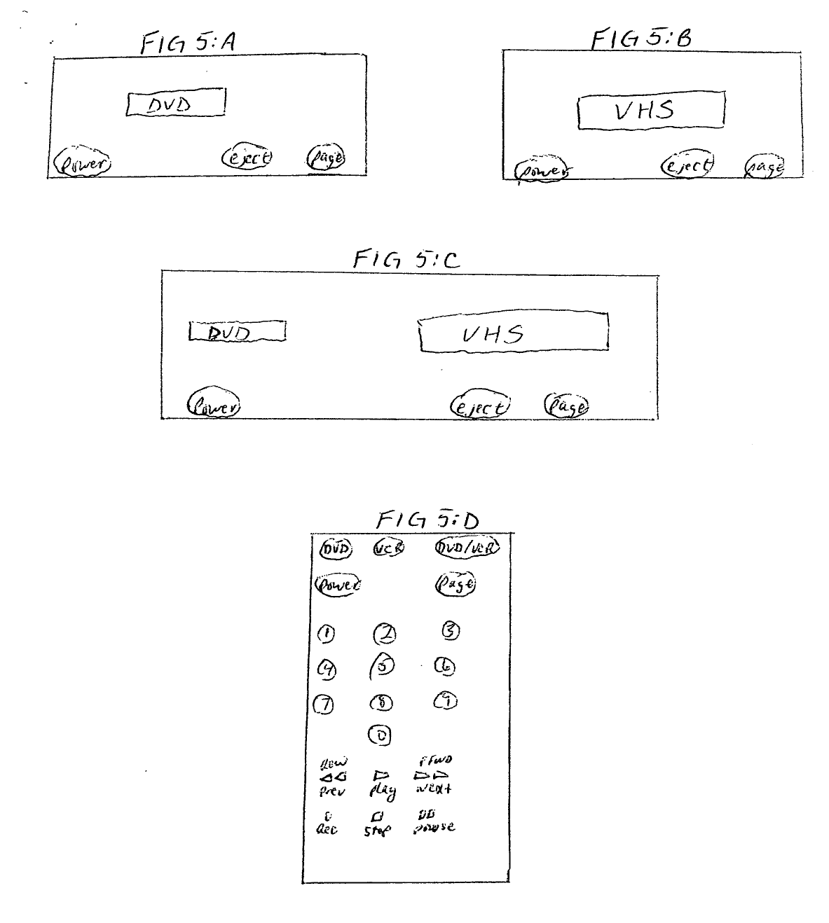

The page function for the remote control will be a very helpful tool in recovering a remote control that too commonly gets misplaced. The page function for remote control will be similar to that of a cordless phone. The universal remote control will use NICAD (Nickel Cadmium) or NIMH (Nickel Metal Hydride) which are rechargeable batteries. The remote controls using NICAD or NIMH would have a rechargeable docking station with a page button on the docking station to activate the page function in case the remote control gets misplaced and a page button on the remote control itself to deactivate it once it is found. If the remote control uses either double A(AA), triple A(AAA), or 9V batteries, then the page button will be on the electronic device such as a T.V., DVD, VCR, Stereo System, DVD/VCR combo, satellite receiver, cable receiver, and a projector to activate the page function in case the remote control gets misplaced and a page button on the remote control itself to deactivate it once it is found. The remote controls and the rechargeable docking stations will be made out of hard plastic material. There will be two types of rechargeable docking station that will be powered by a class 2 AC/DC transformer or power supply. Both power supplies will utilize similar technologies that are parallel to the cordless and cellular phones. The cordless phone has somewhat of a bulky docking station and the cellular phone has a compact docking station.

### TV With Remote

The remote control for the TV with the page function will locate the missing remote control in the time of need. The page button on the TV will activate the page function when the remote control is misplaced. The page button on the remote will deactivate the page function when the remote control is found.

### Digital Cable Box/Satellite Receiver

The digital cable box/satellite receiver with the page function will have the ability to locate the missing remote. The page button on the remote control will serve as a deactivating function once the remote control is found.

### Stereo System with Remote Control

The remote control will be able to control the stereo and the page function will possess the ability to locate the missing remote. The page button on the remote control will serve as a deactivating function once the remote control is found.

### Universal Remote Control with Recharging Dock

The universal remote with recharging dock will have the ability to control devices such as stereo, CD player, DVD player, TV, VCR, cable, and satellite dishes. The page button on the recharging dock or power supply will serve as an activating function to locate the remote control and the page button on the universal remote control will serve as a deactivating function once the remote control is found.

### DVD/VCR and DVD-VCR Combo

The DVD/VCR or DVD-VCR combo with the page button will possess the ability to find the missing remote control. The page button on the remote control will serve as a deactivating function once the remote control is found.

1. I, Eddie Simmons, claim the Page Function for Remote Control solely as my invention: My sole and main purpose of this idea is to obtain a patent for the page function for remote control.
